(19) United States
(12) Patent Application Publication
(10) Pub. No.: US 2026/0192336 A1
(43) Pub. Date: Jul. 9, 2026

(54) Exciter

(71) Applicant: Weir Minerals Australia Limited, Artarmon NSW (AU)

(72) Inventor: Carl Walker, Marrickville (AU)

(21) Appl. No.: 19/131,833

(22) PCT Filed: Nov. 9, 2023
(86) PCT No.: PCT/IB2023/061338

§ 371 Date: May 21, 2025

(30) Foreign Application Priority Data
Nov. 25, 2022 (GB) 2217654.9

(51) Int. Cl. B07B 1/28; B06B 1/16

(52) U.S. Cl. CPC B07B 1/284; B06B 1/16

(57) ABSTRACT

An exciter housing (12) for a vibrating screen. The housing comprises a body having an upper portion (14), a lower portion, and opposing ends (18). At least one of the opposing ends has an opening for receiving a gear. The housing further comprises a passageway extending between the ends and being defined by opposing walls.

### TECHNICAL FIELD

The present invention relates to an exciter for a vibrating screen, such as vibrating screens used in minerals processing, and to a housing for an exciter.

### BACKGROUND ART

Exciters are used to drive vibration machines, for example vibrating screens, by introducing a force in one direction and corresponding motion into the vibration machine.

Known exciters typically include a housing assembly, a pair of toothed gears located within a cavity defined by the housing assembly and supported by a pair of spaced apart contra-rotating shafts extending though the housing, bearings for locating the rotating shafts relative to the housing, and unbalanced/eccentric masses mounted to each end of each shaft. In use, the gears are configured in an intermeshing relationship with each other. Typically, rotation of the gears assists in distributing a lubricating fluid contained inside the housing. Rotation of the eccentric masses are synchronized for counter/clockwise rotation at the same speed.

Exciters have been around for many years and known to form part of a vibrating screen assembly. Known exciters for use with vibrating screens, however, comprise numerous problems. For example, the gears of known exciters, such as the one described in Australian patent no. 2016299439, are inserted into the exciter housing from an upper opening. This arrangement forms a weak point in the housing assembly that impacts housing stiffness and deflection when forces created by the eccentric weights are acting in some directions. This is not desirable.

Another problem with known exciters for use with vibrating screens relates to distribution of the lubrication fluid contained within the housing assembly. Known exciters typically use a lubrication fluid to lubricate the bearings. The lubrication fluid is contained under gravity within a cavity defined by the housing assembly and must be distributed from the cavity to the bearings. Generally this distribution is via the gears. One solution can be found in Australian patent no. 2016299064 which describes an exciter including openings for allowing oil to pass to the bearings. Some existing exciters also use the holes in the bearing outer race/ring, which may become blocked by the centre ring of the bearing, which rotates much slower than the speed of the bearing inner/shaft. This behaviour essentially blinds the oil holes in the outer ring, limiting flow. Also the action of the bearing rolling elements actively forces the oil outwards, providing a further barrier to useful flow. In summary, the lubrication of existing exciters is generally marginal at best.

Another problem of known exciters for use with vibrating screens relates to orientation of the exciter itself relative to the vibrating screen on which the exciter is to be mounted. It is known that exciters may be placed in any position on a vibrating screen, however, typically an exciter is orientated at an angle of about 45 degrees to the horizontal. Exciters used with vibrating screens are typically heavy, weighing upwards of 1000 kgs, and can generate forces of above 1000 kN. When an exciter is mounted at 45 degrees to the horizontal this results in the upper bearing being a significant distance from the sump containing the oil. As the exciters get bigger, this distance gets bigger. This makes splash lubrication difficult to implement effectively because the top bearings are typically not lubricated properly. On start-up there may also be a delay in oil reaching the upper bearings.

Another problem relates to the thermal performance of the exciter. Oil life (the length of time that oil functions as an effective lubricant) diminishes rapidly at high temperatures (sometimes above 90 degrees Centigrade), so passive heat rejection (or dissipation) is a desirable feature. Existing designs have low surface area for a given mass, and many designs do not use any means of additional heat rejection.

It is among the objects of embodiments of the present invention to overcome or mitigate one or more of the above disadvantages or other disadvantages of the prior art, or to provide a useful alternative.

A reference herein to a patent document or other matter which is given as prior art is not to be taken as an admission that the document or matter was part of the common general knowledge as at the priority date of any of the claims.

### SUMMARY OF THE INVENTION

This summary is provided to introduce a selection of concepts that are further described in the detailed description below. This summary is not intended to identify indispensable features of the claimed subject matter, nor is it intended for use as an aid in limiting the scope of the claimed subject matter.

According to a first aspect of the invention there is provided an exciter for a vibrating screen, the exciter comprising: a unitary body having: an upper portion; a lower portion; opposing walls comprising a front wall and a back wall; opposing ends, at least one of the ends having an opening for receiving a gear; and a passageway extending between the ends and defined by the upper and lower portions and the opposing walls, wherein each of the opposing walls has a pair of spaced apart through holes and the passageway includes a pair of chambers, each chamber being in registration with corresponding spaced apart through holes, and each chamber extending transverse to the length of the passageway.

Optionally, each end has an opening for receiving a gear.

Optionally, the passageway comprises a longitudinal passageway.

Optionally, each end has a planar orientation, transverse (in some embodiments perpendicular) to the longitudinal passageway. Alternatively, each end may have an arcuate shape that curves towards the upper portion.

Optionally, the passageway may extend between the openings defined by the ends.

Optionally, the upper and/or lower portion comprises a non-planar outer and/or inner surface. The, or each, non-planar surface may have a profiled shape corresponding to a shape of the gear (or gears) mounted within the body. In some embodiments, the, or each, non-planar surface comprises two arcs extending along the passageway, with each arc extending for part of the length thereof. Each arc may also define an arcuate cross-section transverse (in some embodiment perpendicular) to the passageway. The non-planar inner surface (of the upper and/or lower portion) may define a plurality of chambers.

In some embodiments, neither the upper portion nor the lower portion defines an aperture large enough for a gear to be inserted therethrough. The upper portion may comprise continuous solid material free from any apertures that would significantly reduce the rigidity of the upper portion.

Optionally, at least one of the ends is significantly smaller than any of the upper portion, the lower portion, and each of the opposing walls.

Optionally, the opposing ends are at opposite sides of the longitudinal passageway.

In some embodiments, one gear is inserted through a first of the opposing ends, and a second gear is inserted through the second of the opposing ends.

By including openings at one or both ends, the body can have a continuous, solid upper portion, which maximises strength of the body.

Advantageously, the openings for receiving a gear are positioned at the opposing ends of the body thereby maximising strength of the body during operation, in particular, when one or more eccentric weights are mounted to the shafts of the exciter and exert a force in an upwards and downwards direction (i.e. towards and away from the upper portion of the body).

In some embodiments, the body may comprise a housing. Optionally, a bearing cover abutment surface extends around each of the spaced apart through holes. Each through hole may extend substantially perpendicular to the length of the passageway.

In some embodiments, the bearing cover abutment surface may include a plurality of channels (also referred to as ports), wherein the plurality of channels (or ports) may be circumferentially spaced apart around the through holes. In some embodiments, the plurality of channels may be different shapes and/or sizes. In some embodiments, the plurality of channels may be the same size and/or shape.

In some embodiments, the channels extend through the front and back walls to provide fluid communication between the bearing cover abutment surface and the passageway. In some embodiments, each channel extends through the front and back walls such that a channel in one bearing cover abutment surface aligns with a respective channel in the opposing bearing cover abutment surface to provide fluid communication between one bearing cover abutment surface, the passageway, and the opposing bearing cover abutment surface. Advantageously, the one or more channels may assist in delivering lubricating fluid to the bearings from one or more chambers defined by the passageway.

In addition, the channels retain oil and thereby provide a reservoir for oil separate from the passageway (which acts like a sump for the oil). This has the advantage of reducing frictional losses because less oil collects in the passageway (than if these channels were not provided), so the gear moves through less oil as it rotates, but without reducing the total amount of oil in the housing. Furthermore, these channels (ports) may store this oil close to the surface of the exciter housing, which further aids in heat rejection, compared to the oil being retained in a sump.

The through holes may also include a bearing abutment surface. Each bearing abutment surface may be circular in shape for abutting an outer surface of a bearing cover.

As mentioned above, the body comprises a passageway. In some embodiments, the passageway includes a reservoir for holding a fluid. In some embodiments, the fluid may be in the form of a lubricating fluid for lubricating one or more bearings. In some embodiments, a portion of the passageway may act as the reservoir for holding the fluid.

In some embodiments, the passageway comprises at least one arcuate (curved) upper surface and at least one arcuate lower surface. Advantageously, in use, the arcuate surfaces may assist in distributing lubricating fluid evenly between bearings, particularly where the gear has a helical tooth pattern that biases lubricating fluid towards diagonally opposite bearings. The raised portions of the arcuate surfaces may redirect sprayed lubricating fluid (such as oil) towards the bearings.

The chambers are optionally configured to share an opening therebetween.

Typically, each chamber may be substantially circular in shape. In some embodiments, the pair of chambers are arranged side by side and share an opening. Advantageously, fluid from the reservoir may pass from one chamber to the other, thus assisting in distributing the fluid inside the chambers. In some embodiments, each chamber is defined by the at least one arcuate side wall.

In some embodiments, the body may include at least one lug. In some embodiments, the body may include at least a pair of spaced apart lugs; in other embodiments, two pairs of lugs may be provided, one pair of lugs near each of the two opposing ends. The pair of lugs may be adapted to allow the body to be lifted at a 45 degree angle to the horizontal. In some embodiments, each lug may extend upwardly, away from an upper surface of the body. In some embodiments, each lug may be spaced inwardly from an end of the body. In some embodiments, each lug may be integrally formed with the body. In some embodiments, each lug and the body may form a unitary body.

In some embodiments, each lug may extend away from the body at an angle of 45 degrees from the centre of gravity of the body. Advantageously, when lifted using, preferably, a pair of lugs, the exciter is already orientated at a 45 degree angle ready for mounting to an exciter machine on a 45 degree angle, thereby facilitating mounting of the exciter. When the exciter is to be transported in the horizontal position, both pairs of lugs may be used.

In some embodiments, the body may further include a pair of feet comprising one or more spaced apart apertures each for receiving a fastener. Advantageously, the exciter may be secured to a vibrating screen machine. The feet may extend along a length of the body. The feet may extend downwardly and away from the body. The feet may be shorter in length in comparison to the overall length of the exciter. In some embodiments, the feet may be integrally formed with the body. In some embodiments, the feet and body may form a unitary body.

As mentioned above, the body of the exciter includes opposing ends, each end having an opening for receiving a gear. In some embodiments, each opening is, or is substantially, rectangular in shape. Further, in preferred embodiments, each opening may be of any dimension suitable for allowing the gear to pass into the passageway of the body.

According to a second aspect there is provided an end cover for a unitary exciter housing body having a longitudinal passageway defined by a top, bottom, opposing sidewalls, and opposing ends, where each opposing end is smaller than the top, bottom or opposing sidewalls, and where at least one of the opposing ends defines an opening for receiving a gear, the end cover comprising: a mounting surface perimeter for coupling to the exciter housing body; an arcuate base upstanding from the mounting surface perimeter and having a front wall, a back wall spaced apart from the front wall, and a thermal cooling feature; wherein the end cover is configured to cover the opening of the exciter housing body.

The thermal cooling feature optionally comprises a plurality of fins upstanding from the arcuate base. By using the thermal cooling feature, the available volume for lubrication fluid is increased. This also enables the lubrication fluid to be held in close thermal contact with the thermal cooling feature thereby delivering an enhanced cooling effect.

The arcuate base optionally defines a cavity on an inner surface thereof.

In some embodiments, each opposing end further includes an end cover abutment surface. In some embodiments, the end cover abutment surface may be adapted to abut a corresponding end cover. The end cover abutment surface optionally extends around a perimeter of the opening for receiving a gear. The end cover abutment surface is optionally planar, or substantially planar.

The end cover abutment surface may include one or more apertures each for receiving a fastening. In embodiments which include more than one aperture, the apertures may be spaced apart. Typically, the apertures may extend around each of the opposing end openings.

In some embodiments, the body may be longitudinal. Typically, the opposing ends of the body form the ends of the longitudinal body. The longitudinal body may be symmetrical along a central longitudinal plane and/or along a central transverse plane. Advantageously, the body may orientated in an upright or upside down orientation while maintaining the same functionality.

Typically, the body is unitary; optionally cast as a single body portion.

According to a third aspect there is provided an exciter comprising: an exciter housing body as set forth above; a pair of end covers, each end cover being mounted to an end of the exciter housing body and being configured to cover one of the opposing end openings; and a pair of bearing covers, each bearing cover being mounted on a respective bearing cover abutment surface of the housing body; wherein the housing body, end covers, and bearing covers form an internal cavity including the passageway and being configured to direct a contained fluid therearound.

In some embodiments, the end cover may include an inlet/outlet for introducing and/or draining fluid from the passageway of the body.

In some embodiments, the exciter may further include at least one bearing cover. In some embodiments, the exciter may include two pairs of bearing covers. Each pair of bearing covers may include a first bearing cover and a second bearing cover. The first bearing cover of the pair of bearing covers may be in the form of a left bearing cover. The second bearing cover of the pair of bearing covers may be in the form of a right bearing cover. The left bearing cover may be a mirror configuration of the right bearing cover.

The exciter may further include at least one shaft. In some embodiments, the exciter may include a pair of shafts, in the form of a first shaft and a second shaft. The first shaft may be shorter than the second shaft. Nevertheless, each shaft may be in the form of a hollow shaft member. Advantageously, the hollow shaft members may assist in minimizing the overall weight of the exciter.

The exciter may further include at least one unbalanced/eccentric weight. In some embodiments, the exciter may include two, four or eight unbalanced/eccentric weights.

The exciter may further include at least one bearing. In some embodiments, the exciter may include at least four bearings. Each bearing may be configured to be received within a through hole of the body of the exciter. Each bearing may be supported by the wall of the body.

The exciter may include a housing assembly comprising the body of the housing, the at least one bearing cover, and the end covers. In one preferred embodiment, the housing assembly may include the body of the housing, two pairs of bearing covers, and a pair of end covers.

Accordingly to another aspect of the present invention there is provided an end cover for an exciter comprising a unitary housing body defining an opening for receiving a gear, the end cover comprising: a front wall; a back wall spaced apart from the front wall; and, an arcuate wall extending between the front wall and back wall, wherein the end cover is configured to cover the opening of the unitary housing body.

The arcuate wall may be concave in shape. Advantageously, when the end cover is mounted to the housing body of an exciter, the arcuate wall may assist in directing and/or distributing fluid around a chamber of the body.

In some embodiments, the front wall, back wall and arcuate wall may form an end portion. The end portion may comprise an open side. In some embodiments, the end cover may further comprise a flange extending outwardly away from a perimeter of the open side of the end portion for abutting an end cover abutment surface of the housing body.

Advantageously, a pair of end covers may each be secured to the housing body along their respective flanges thereby enclosing opposing ends of a passageway formed in the housing body, thereby forming an internal volume suitable for containing a fluid.

In some embodiments, the end cover may include at least one elongate member extending transversely between the front wall and the back wall. The at least one elongate member may be in the form of an elongate rod.

In some embodiments, the end cover may further include one or more fins extending from an outer facing surface of the arcuate wall for dissipating heat away from an inner facing surface of the arcuate wall. Advantageously, the fins may assist in cooling fluid contained within the housing body.

In some embodiments, the end cover may also define at least one drain aperture configured to pass a fluid when the end cover is secured to the housing body. In some embodiments, the end cover includes two or four drain apertures. Each drain aperture is adapted to receive a drain or a plug.

In some embodiments, the end cover may define at least one reinforced aperture in each of the front wall and the back wall. In some embodiments, the end cover includes two or four such reinforced apertures. The reinforced apertures defined by the front wall or the back wall may provide protection for the one or more fins and any sensors coupled to the end cover.

According to another aspect of the present invention there is a provided a housing assembly for an exciter, the housing assembly comprising: a unitary housing body comprising: an upper portion; a lower portion; opposing ends, each end having an opening for receiving a gear; and, a pair of end covers, each end cover for covering an end opening of the housing body, wherein the housing body and end covers form an internal cavity defined by at least one internal side wall shaped to direct a contained fluid around the cavity.

According to another aspect of the invention there is provided a bearing cover for an exciter, the bearing cover comprising: a wall having an inner facing side, an outer facing side and a bore extending through the wall for receiving a shaft; the inner facing side defining: a first shaped recess, wherein the first shaped recess extends around the aperture and defines a first volume; and, a second shaped recess, the second shaped recess having an enlarged end portion defining a second volume and a narrow channel portion connecting the first volume of the first shaped recess and the second volume of the enlarged end portion.

In some embodiments, the second shaped recess is in the form of an upper shaped recess. Typically, the inner facing surface includes a set of upper shaped recesses spaced apart around the first shaped recess.

In some embodiments, the inner facing surface may define a third shaped recess. The third shaped recess may act as a fluid reservoir. In some embodiments, the third shaped recess may include an enlarged lower portion defining a third volume and one or more channels connecting the first volume to the third volume. The first, second and third volumes may all be in fluid communication.

The first shaped recess may comprise a central recess, the second shaped recess may comprise an upper recess and the third shaped recess may comprise a lower recess.

In some embodiments, the bearing cover may further include one or more apertures each for receiving a fastener. Advantageously, the bearing cover may be secured to a body of an exciter.

As mentioned above, the wall has an outer facing side. In some embodiments, the outer facing side comprises one or more ribs or fins extending away from an outer surface of the wall. In one preferred embodiment, the one or more ribs or fins may be arcuate. In another preferred embodiment, the one or more ribs or fins may be straight. In yet another embodiment, the ribs or fins may be a combination of arcuate and straight fins. Advantageously, the ribs/fins may assist in cooling lubricating fluid held within the shaped recesses.

According to another aspect of the invention there is provided an eccentric weight for mounting to an exciter shaft, the eccentric weight comprising: a shaft mounting portion defining an opening for receiving the exciter shaft; a plurality of spaced apart arms extending radially outward from the mounting portion; a weight mounting portion defining a plurality of spaced apart openings each configured to receive a weight member.

In some embodiments, the body comprises at least four spaced apart arms. Each arm may be in the form of an elongate arm. Each arm may have a pair of opposing ends, in the form of a first end and a second end. The first end may be mounted on the shaft mounting portion and the second end may be mounted on the weight mounting portion.

In some embodiments, each opening defined by the weight mounting portion may be circular in shape. Each opening may be in the form of a bore which extends through a width of the weighted mounting portion.

In some embodiments, the shaft mounting portion may include an inner facing surface. The inner facing surface may be an abutment surface for abutting the exciter shaft. The inner facing surface optionally defines the opening for receiving the exciter shaft. The size and shape of the opening of the shaft mounting portion corresponds, or substantially corresponds, to the size and shape of at least a portion of an outer surface of the exciter shaft.

The eccentric weight may be forged.

Prior art exciter housings typically have variable radial stiffness and variable stiffness depending on the load direction/position of the eccentric mass. It should now be appreciated that the above aspects have consistent radial stiffness (except in the inward direction which has greater stiffness due to the bearing arrangement) and uniform stiffness with the varying load direction due to the shape of the housing, and the distribution of material.

### BRIEF DESCRIPTION OF THE DRAWINGS

These and other aspects of the present invention will now be described, by way of example only, with reference to the accompanying drawings, in which:

FIG. 1 is a perspective view of an exciter assembly in accordance with an embodiment of the present invention;

FIGS. 2, 3, 4 and 5 are top, front, side and bottom views respectively of a housing body which forms part of the exciter assembly of FIG. 1;

FIG. 6 is a front view of half of the housing of FIG. 1;

FIG. 7 is a perspective view of an end cover in accordance with an embodiment of the present invention;

FIGS. 8 to 11 are top, front, side and bottom views of the end cover of FIG. 7;

FIG. 12 is a front perspective view of a pair of left and right bearing covers;

FIG. 13 is a rear perspective view of the pair of bearing covers of FIG. 12;

FIG. 14 is a front view of the left bearing cover of FIGS. 12 and 13;

FIG. 15 is a rear view of the left bearing cover of FIG. 14;

FIG. 16 is a perspective view of an eccentric weight in accordance with an embodiment of the present invention;

FIGS. 17 and 18 are top and front views respectively of the exciter assembly of FIG. 1;

FIG. 19 is a top view of the exciter assembly of FIG. 1, similar to FIG. 17 but with the weights in a different position;

FIG. 20 is a section view taken along line 20-20 of FIG. 19;

FIG. 21 is a section view taken along line 21-21 of FIG. 19;

FIG. 22 is a section view taken along line 22-22 of FIG. 19;

FIG. 23 is a section view taken along line 23-23 of FIG. 18;

FIG. 24 is a section view taken along line 24-24 of FIG. 19, with the exciter assembly inclined at a position it would disposed at in use on a screen;

FIG. 25 is a section view taken along line 25-25 of FIG. 19 without the end covers attached, with the exciter assembly inclined at a position it would disposed at in use on a screen;

FIG. 26 is a section view taken along line 26-26 of FIG. 19, with the exciter assembly inclined at a position it would disposed at in use on a screen; and

FIGS. 27A, B, and C are three different views (perspective from above, side, and perspective from below, respectively) of the exciter assembly of FIG. 1 with the eccentric weights in a first position;

FIGS. 28A, B, and C are three different views (perspective from above, side, and perspective from below, respectively) of the exciter assembly of FIG. 1 with the eccentric weights in a second position;

FIGS. 29A, B, and C are three different views (perspective from above, side, and perspective from below, respectively) of the exciter assembly of FIG. 1 with the eccentric weights in a third position;

FIGS. 30A, B, and C are three different views (perspective from above, side, and perspective from below, respectively) of the exciter assembly of FIG. 1 with the eccentric weights in a fourth position; and

FIG. 31 is a front perspective view of an alternative housing body according to another embodiment of the present invention.

### DESCRIPTION OF EMBODIMENTS

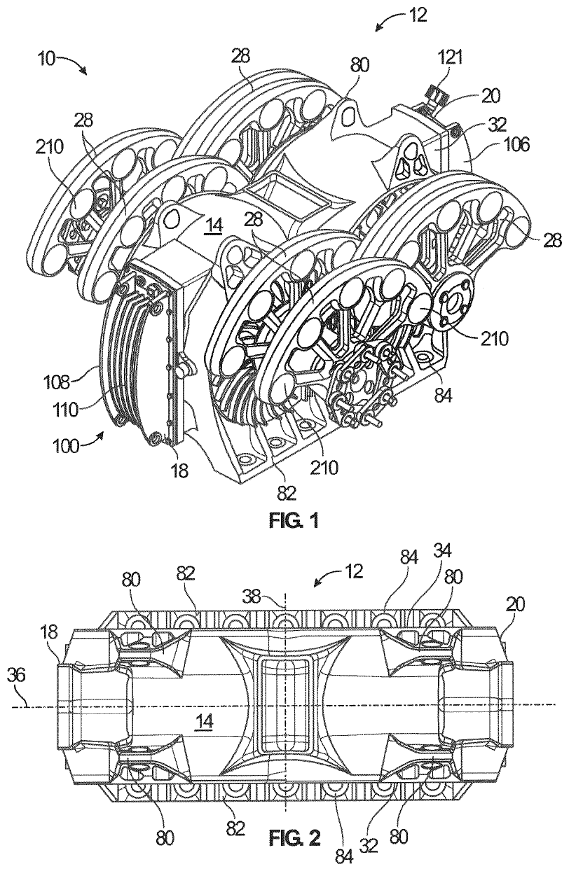

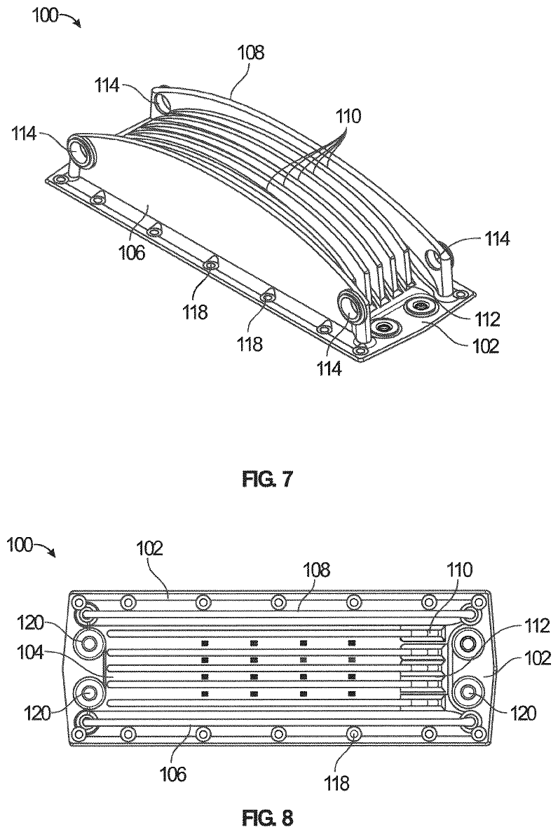

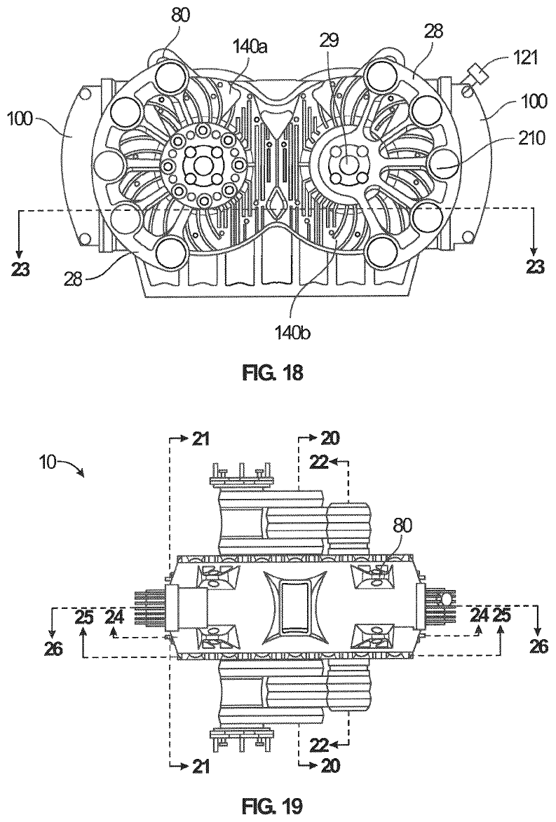

FIG. 1 shows an exciter assembly 10 (also referred to as an exciter) for a vibrating screen (also shown in FIGS. 17 to 19) in accordance with an embodiment of the present invention. The exciter 10 comprises a body, in the form of an elongate housing 12, in accordance with another embodiment of the present invention. Features of the housing 12 are best seen in FIGS. 2 to 5. The housing 12 includes an upper portion (or top) 14, a lower portion (or bottom) 16, and opposing ends 18, 20, each opposing end having an opening 22, 24 (opening 22 is best seen in FIG. 21) for receiving gears 26 (best seen in FIGS. 23 and 26). Having each of the openings 22, 24 defined by one of the opposing ends 18, 20 of housing 12 maximises the strength of the housing 12, which is highly advantageous during operation, in particular, when one or more eccentric weights 28 are mounted to exciter shafts 29 (best seen in FIG. 17) and exert a force in an upward direction, i.e. towards the upper portion 14 of the housing 12, best shown in FIGS. 26A to C.

The housing 12 further includes a passageway 30 (best seen in FIG. 6) extending between the openings 22, 24 and defined by a front wall portion 32, a back wall portion 34, the upper portion 14 and the lower portion 16.

FIGS. 2 to 5 show the elongate housing 12 in more detail. The housing 12 is generally symmetrical along the central longitudinal plane 36 (best seen in FIG. 2) and further along the central transverse plane 38. In use, the housing 12 may be oriented in an upright or upside down orientation while maintaining the same functionality.

The front wall portion 32 and back wall portion 34 of housing 12 each define apertures which together provide spaced apart through holes 40, 42 extending therethrough (best seen in FIGS. 3 and 6). As described in more detail below, the through holes 40, 42 are used to support exciter shafts 28 having eccentric weights 26 mounted thereon.

As best shown in FIG. 6, through holes 40, 42 extend transverse to the length of passageway 30 (i.e. parallel with the central transverse plane 38). Each through hole 40, 42 is further defined by a bearing abutment surface 50 (which is part of the housing 12) extending around each through hole 40, 42 for supporting a bearing 52 (best seen in FIGS. 21 to 23), as described in more detail below.

Bearing abutment surface 50 includes a plurality of channels 54 spaced apart around each of the through holes 40, 42. In the preferred embodiment shown, channels 54 are of the same size and shape. In this embodiment, the channels 54 have a generally rectangular (with rounded lateral edges) cross section. In other embodiments, channels 54 may be irregular in size and shape, or may have a different uniform shape (such as a circular cross section). The channels 54 extend from the bearing abutment surface 50 to the passageway 30 to provide a fluid communication path through each of the front and back wall portions 32, 34.

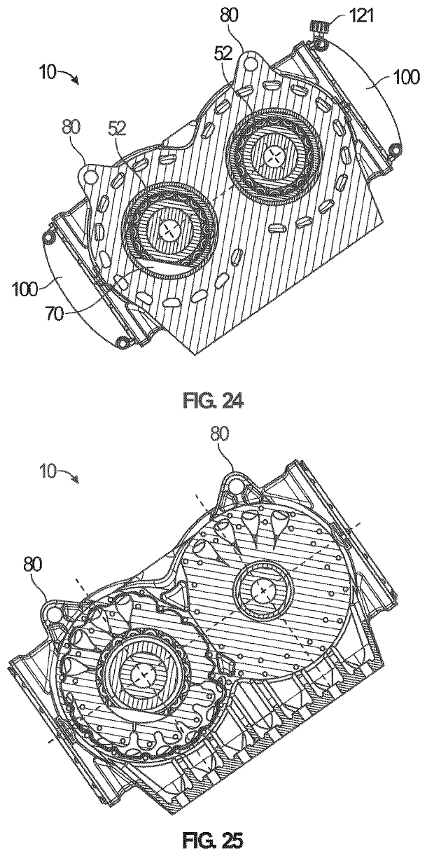

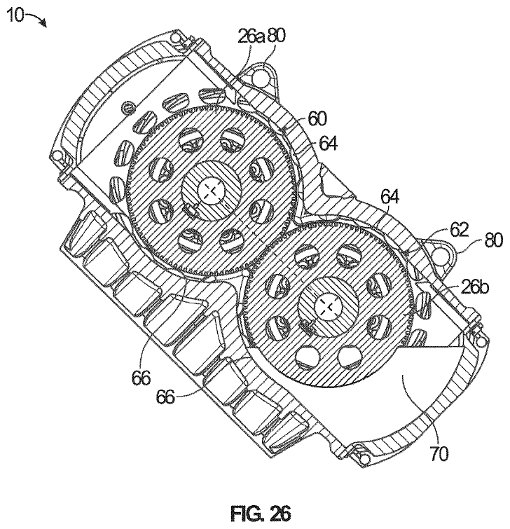

Turning to FIG. 26, the housing 12 further defines a pair of chambers 60, 62 as part of the passageway 30. Each chamber 60, 62 having arcuate upper 64 and lower 66 surfaces defined by an inside surface of the upper portion 14 and an inside surface of lower portion 16, respectively. Each pair of arcuate upper 64 and lower 66 surfaces is generally concentric with its respective through hole 40, 42. A central part of each of the upper 64 and lower 66 surfaces defines a gap at which a gear 26a mounted in one of the chambers 60 meshes with a gear 26b mounted in the other chamber 62. In use, at least a portion of passageway 30 acts as a reservoir (or sump) for containing lubricating fluid 70 (see FIGS. 21, 23, 24 and 26) and channels 54 assist in distributing fluid 70 to the bearings 52 from chambers 60, 62. Advantageously, lubricating fluid 70 from the reservoir may pass from one chamber 60 to the other chamber 62 (in either direction), thereby assisting in distributing the lubricating fluid 70 inside chambers 60, 62. Overheating of an exciter is a significant problem, which is alleviated by this design feature.

The arcuate shape of the upper 64 and lower 66 internal surfaces assists in directing the lubricating fluid 70 towards the gears 26 mounted within housing 12. The rotation of the gears 26, in use, also assist in directing the lubricating fluid 70 into the channels 54.

Housing 12 includes four lifting lugs 80 and a pair of feet 82 extending longitudinally for most, or substantially all, of the length of the housing 12. The lugs 80 are spaced inwardly from the opposing ends 18, 20, and extend upwardly and away from the upper portion 14 housing 12. Each lug 80 is configured to allow the housing 12 to be lifted at a 45 degree angle to the horizontal, which is typically the angle at which the exciter assembly 10 is mounted on a vibrating screen (not shown).

The pair of feet 82 extend downwardly and outwardly and define a row of mounting apertures 84, each mounting aperture 84 being dimensioned to receive a fastener, such as a bolt. In this embodiment, seven mounting apertures 84 are provided, but a larger or smaller number of mounting apertures may be used in other embodiments.

In this embodiment, the housing is cast as a single, unitary part. This providers improved strength and rigidity and avoids any disadvantages associated with complex assembly of a multi-part assembly.

As mentioned above, housing 12 includes opposing ends 18, 20, each end 18, 20 having an opening 22, 24 substantially rectangular in shape and being dimensioned to be able to receive the associated gear 26a,b. This enables the exciter assembly 10 to be assembled by sliding each gear 26a,b through the associated opening 22, 24. This avoids needing to have an aperture in the upper portion 14, thereby increasing the strength of the housing 12.

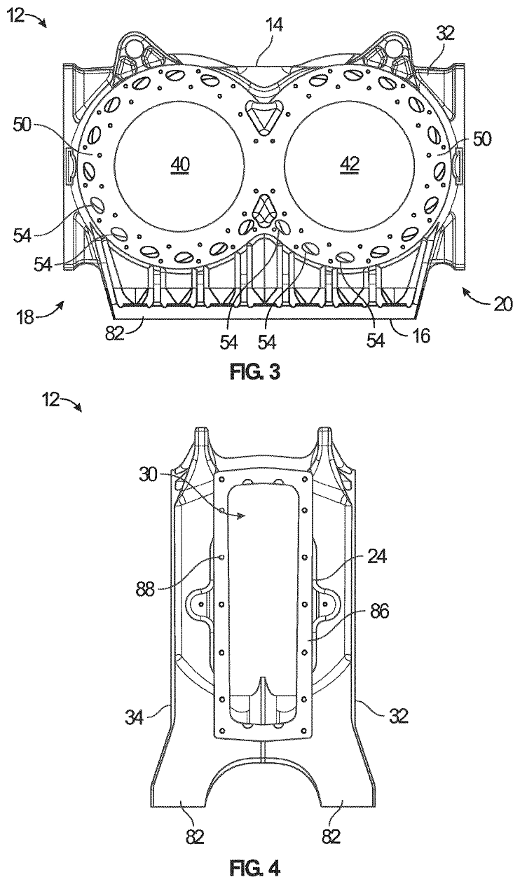

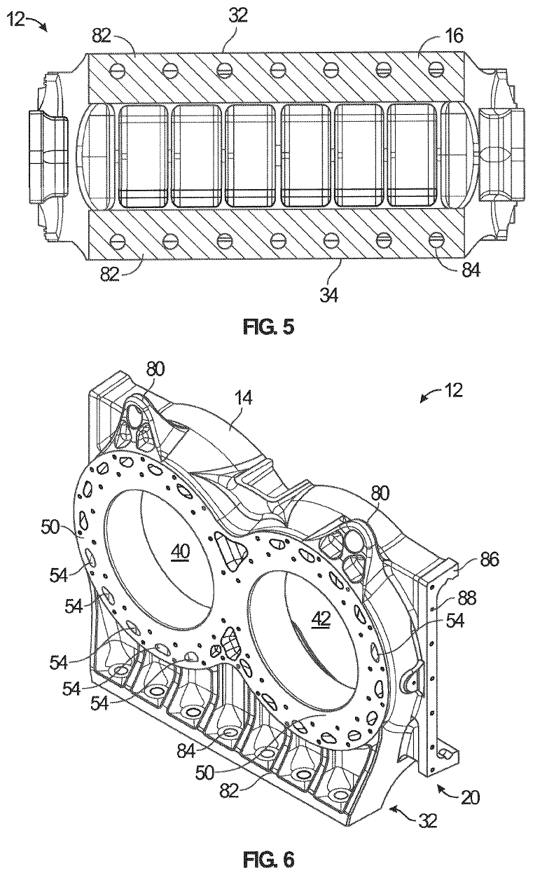

Each opposing end 18, 20 defines an end cover abutment flange 86 (best seen in FIG. 4) extending around a perimeter of the respective opening 22, 24. In the preferred embodiment shown, the end cover abutment flange 86 is planar and includes two rows of spaced apart threaded apertures 88 each for receiving a fastener, such as a bolt.

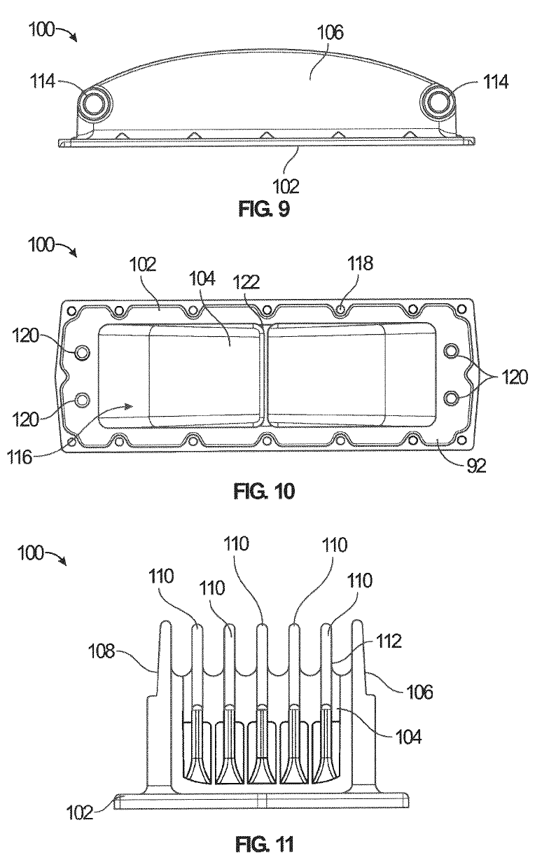

Exciter assembly 10 further comprises a pair of identical (or nearly identical) end covers 100, each end cover 100 being configured to mount against a respective end cover abutment flange 86. The end cover 100 is shown in detail in FIGS. 7 to 11.

Each end cover 100 comprises a mounting surface perimeter 102 disposed around an arcuate base 104 upstanding from the mounting surface perimeter 102. The base 104 includes a front wall 106, a back wall 108 spaced apart from the front wall 106, and a plurality of fins 110 arranged parallel with the front and back walls 106, 108 and upstanding from a central portion of a base surface 112. The central portion of the base surface 112 is located between the front and back walls 106, 108 and has an arcuate shape. The fins 110 assist with cooling the exciter assembly 10 during use.

The front wall 106 and back wall 108 each define a pair of apertures 114, in the form of lugs, configured for receiving a lifting device.

A cavity 116 is defined between an inner surface of the central portion of the base surface 112 and the mounting surface perimeter 102.

Two rows of apertures 118 are provided on the mounting surface perimeter 102 to align with the end cover abutment flange apertures 88 and thereby allow a fastener, such as a bolt, to be inserted through an aperture 118 and into an associated, aligned threaded aperture 88. This allows each end cover 100 to be securely mounted on the housing 12, with the front and back walls 106, 108 and fins 110 being open to the air outside the exciter assembly 10.

The mounting surface perimeter 102 further defines two pairs of oil (or lubrication) apertures 120, one pair at each longitudinal end of the end cover 100, which are configured to receive a removable plug 121 (best seen in FIG. 1), cap, drain element or similar and adapted to allow lubricating fluid 70 to be drained away from (and added to, if desired) passageway 30 when end cover 100 is mounted to housing 12.

The end cover 100 further comprises an elongate member 122, in the form of an elongate rod, mounted on an underside thereof and extending transversely, generally between opposing inner surfaces of the front and back walls 106, 108. Advantageously, elongate rod 122 assists in strengthening the end cover 100. Further, the fins 110, which are open to the ambient air, assist in dissipating heat away from the cavity 116. Advantageously, in the preferred embodiment, fins 110 assist in cooling lubricating fluid 70 contained within housing 12.

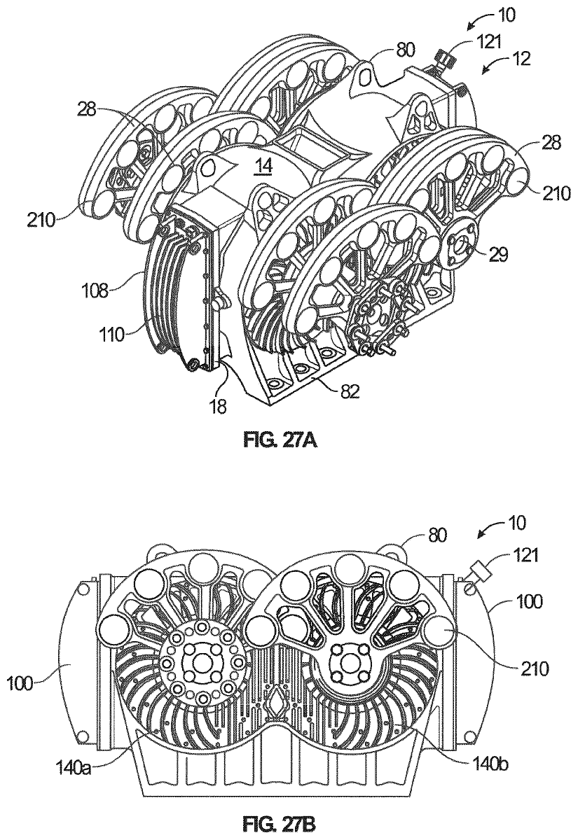

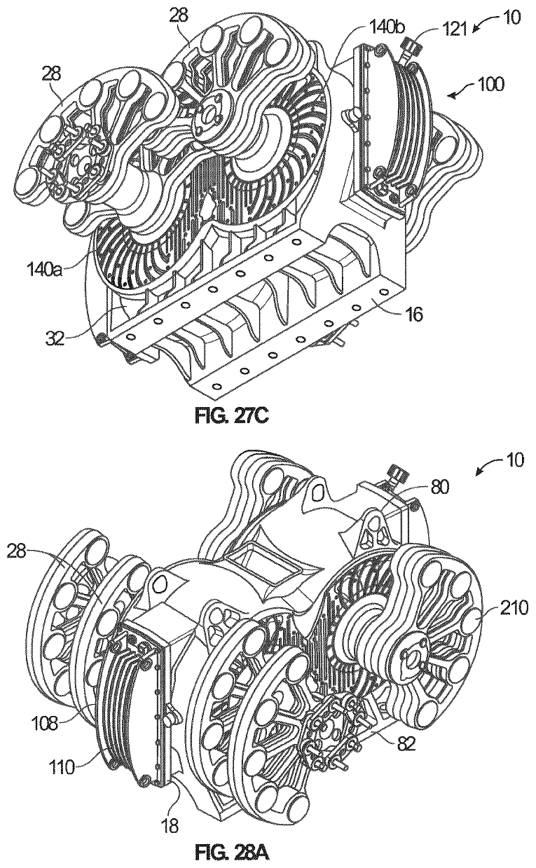

Reference will now be made to FIGS. 12 to 15, which show various views of a pair of bearing covers 140a,b. One pair of bearing covers 140a,b is for the left longitudinal side of the housing 12 (shown in FIG. 6); another identical pair of bearing covers 140a,b is for the right longitudinal side of the housing 12 (shown in FIG. 27A). Since the pair of bearing covers 140a,b are identical, only the left longitudinal side bearing covers 140a,b will be described.

The left longitudinal side bearing covers 140a,b comprise: a bearing cover 140a for the left end of the housing 12; and a bearing cover 140b for the right end of the housing 12. The left bearing cover 140a is a mirror image configuration of the right bearing cover 140b.

Each bearing cover 140a,b comprises a body 142 having a front (outer) side 144, a rear (inner) side 146 and a central aperture 148 extending through the body 142 for receiving one of the shafts 29. Rear side 146 comprises (i) a first shaped recess, in the form of a central, circular recess 150 concentric with the central aperture 148, (ii) a second set of shaped recesses, in the form of upper recesses 152, and (iii) a third shaped recess, in the form of lower recess 154.

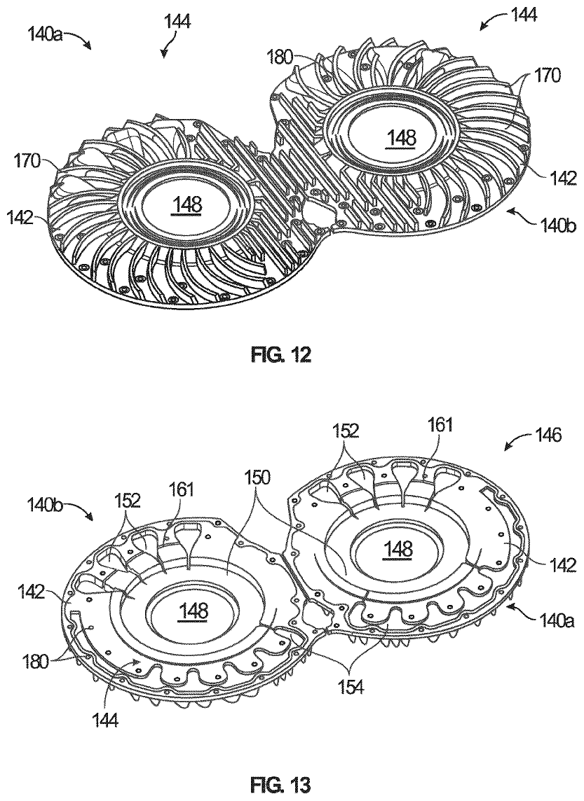

As can be best seen in FIGS. 13 and 15, central recess 150 extends around central aperture 148 and defines a first volume. Upper recesses 152 (of which there are four in this embodiment, although a different number of upper recesses may be used in other embodiments) extend around an upper portion of body 142 and are radially spaced apart around central recess 150 and are in fluid communication therewith via fluid channels 156.

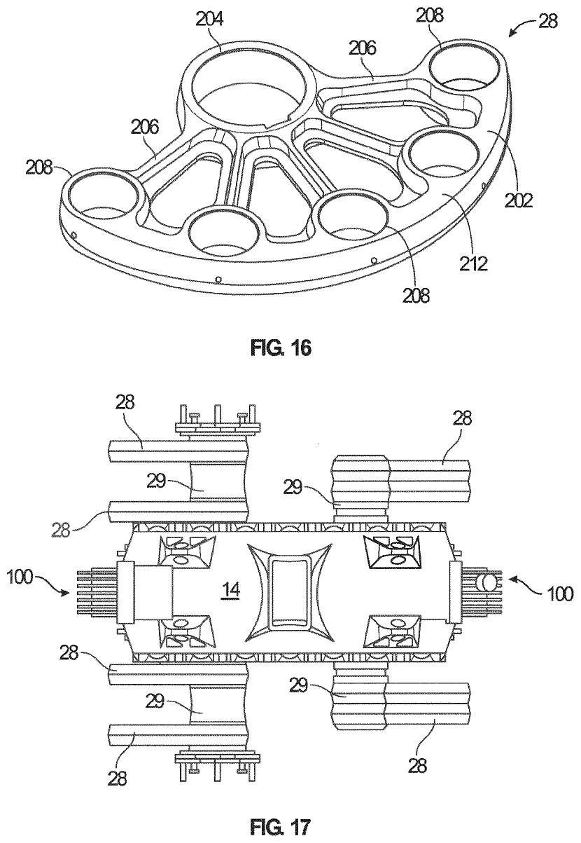

As best seen in FIG. 16, each upper recess 152 is generally teardrop shaped and comprises an enlarged end portion 158 which defines a second volume and a narrow channel portion 160 leading to its respective fluid channel 156.

Adjacent upper recesses 152 are connected by a drain channel 161 that allows lubricating oil to move from one of the upper recesses 152 to its neighbouring (but lower) upper recess 152, thereby facilitating draining of oil when the exciter 10 is not being operated (i.e. when the exciter shafts 29 are not rotating). The drain channels 161 may be recessed from an outer surface of the rear (inner) side 146 by a smaller amount than the upper recesses 152. The drain channels 161 may not be provided in other embodiments, or may have a different shape or configuration to that shown.

Lower recess 154 further extends arcuately around a lower portion of body 142. In use, lower recess 144 acts as a fluid reservoir. Lower recess 144 is profiled and has a generally arcuate lower edge 162 and a plurality of protrusions 164 opposite the lower edge 162 and extending radially towards the central recess 150 to define a third volume. A pair of fluid channels 166 connect each of the two edge protrusions 164 to the central recess 150.

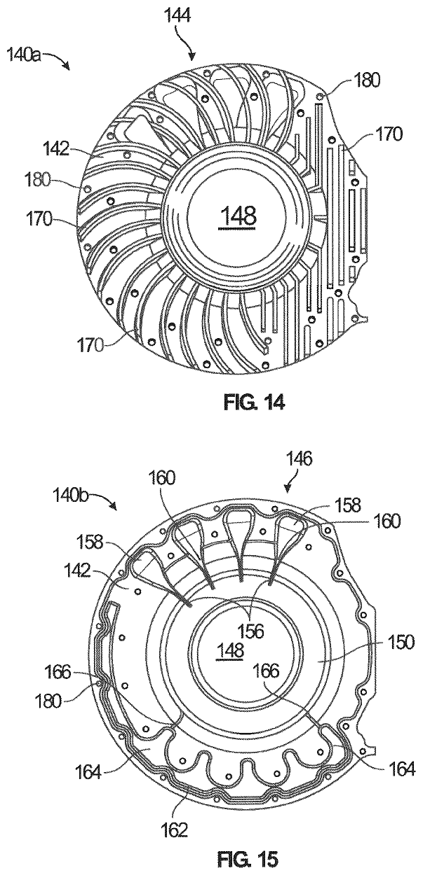

Turning now to the front side 144, which is best shown in FIGS. 12 and 14, the front side 144 comprises a plurality of curved and straight fins 170 upstanding from the body 142. In use, the fins 170 assist in cooling lubricating fluid 70 held within recesses 150, 152 and 154.

Bearing covers 140a,b further define a set of apertures 180 circumferentially spaced in the body 142 around the central aperture 148 as an inner row and an outer row. Each aperture 180 may receive a fastener (such as a bolt) for mounting the bearing covers 140a,b to the housing 12.

Reference is now made to FIG. 16, which illustrates one of the eccentric weights 28 that are mounted to the exciter shafts 29.

The eccentric weight 28 includes a weight body 202 defining a bore 204 dimensioned to receive one of the shafts 29 and spaced apart arms 206. Each spaced apart arm 206 extends radially outwards from the bore 204 to a weight support cylinder 208. There are five weight support cylinders 208 in this embodiment, each defining an opening configured to receive a removable weight 210 (best shown in FIG. 1) and all connected via a peripheral sector member 212.

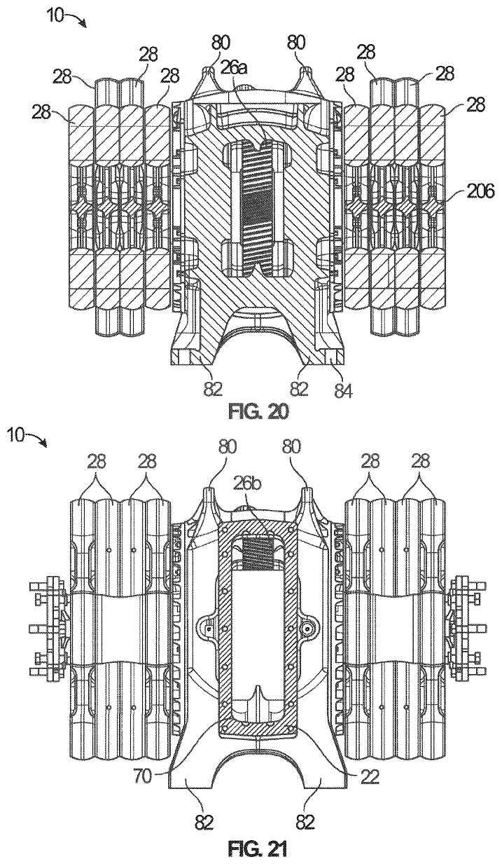

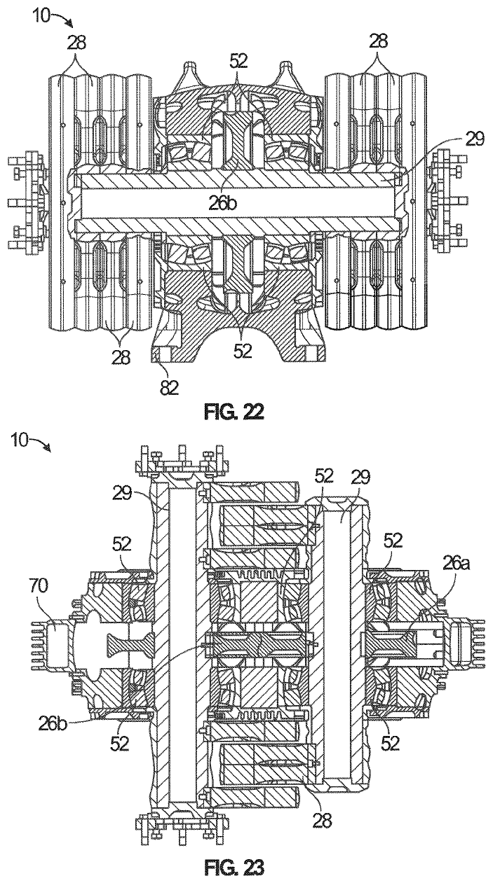

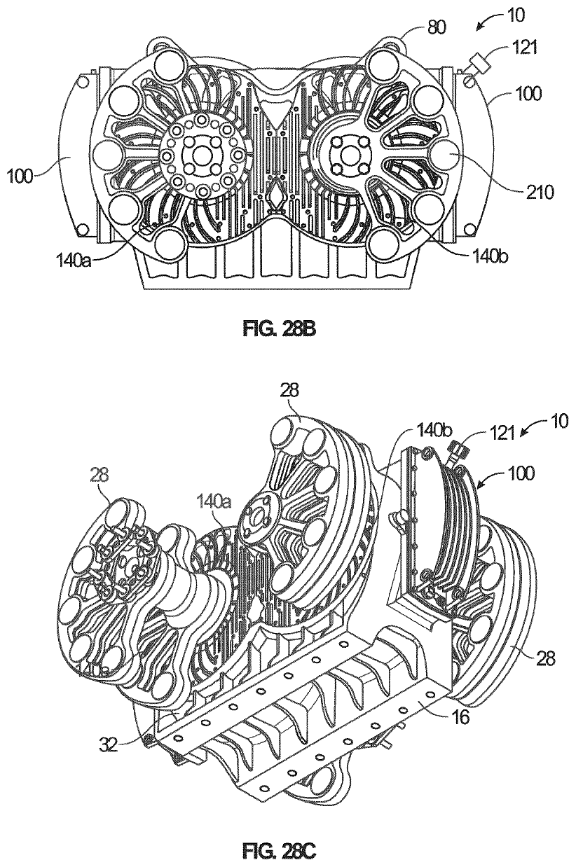

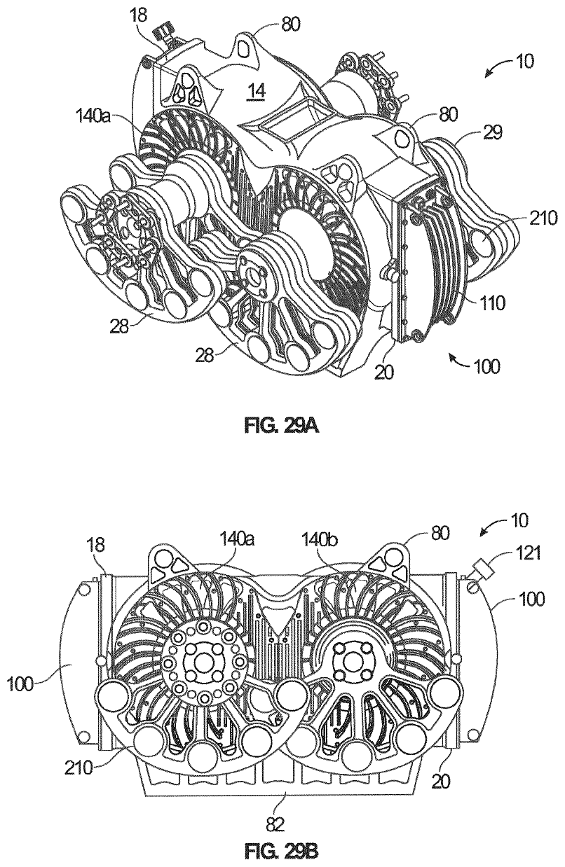

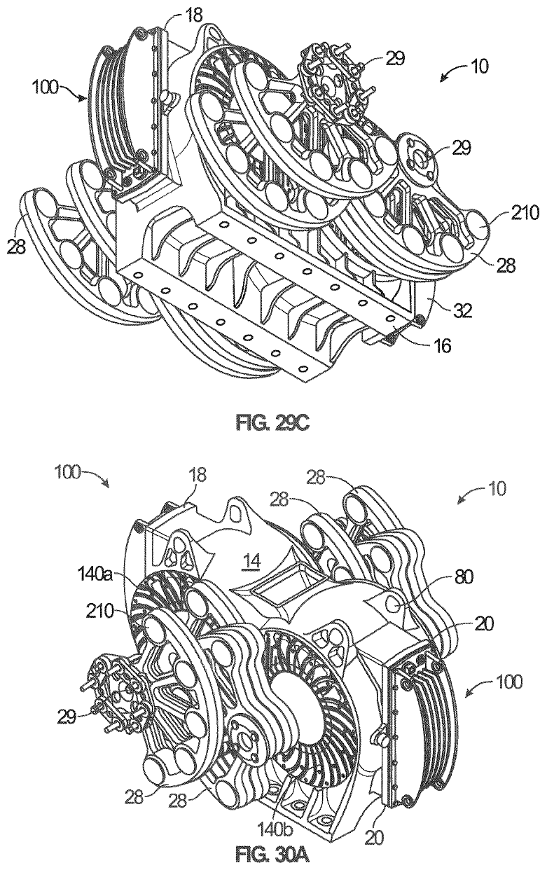

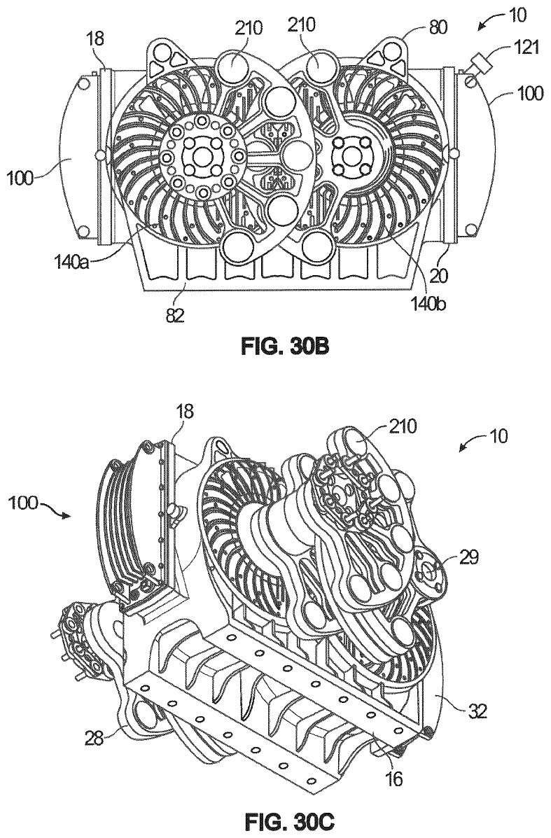

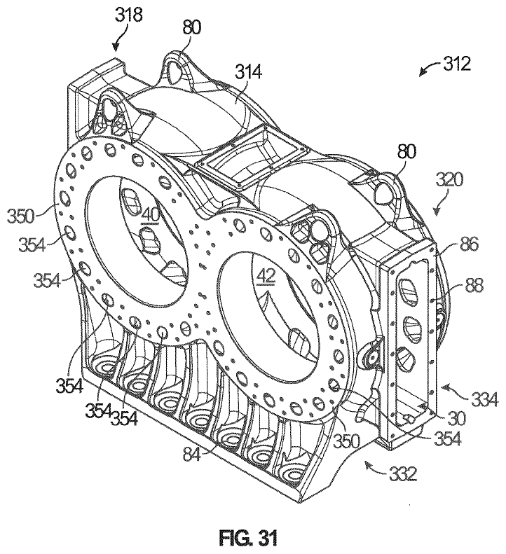

Reference is now made to FIGS. 17 to 30 which show various views of the exciter assembly 10. The exciter assembly 10 comprises a pair of gears 26a,b mounted in the housing 12 and two pairs of bearings 52a,b. Each shaft 29 (of which there are two) is mounted on, and held by, two opposing bearings 52a,b. The pair of bearing covers 140a,b are coupled to the housing 12 and enclose their respective bearings 52a,b. Each of the two shafts 29 supports four eccentric weights 28, each pair of eccentric weights 28 mounted to opposing protruding ends of one of the shafts 29. The left shaft 29 (as viewed in FIG. 17) is longer than the right shaft 29 because on each side of the left shaft 29, the eccentric weights 28 are spaced to accommodate the two eccentric weights 28 mounted on the each side of the right shaft 29 as the shafts 29 rotate.

FIGS. 27 through 30 illustrate the exciter 10 with the eccentric weights 28 at different positions (or phases) as they are rotated by the shafts 29, in use.

It will now be appreciated that this design of exciter assembly 10 has the advantage that lubricating oil 70 is effectively distributed by the operation of the exciter assembly 10. For example, the bearing cover recesses 150, 152, 152, the passageway 30, the chambers 60, 62, and the cavities 116 of the end covers 100 combine to form a reservoir for the lubricating oil 70. As the gears 26 rotate, the gears 26 entrain the oil 70, and the oil 70 is thereby flung around these recesses 150, 152, 152, passageway 30, chambers 60, 62, and cavities 116 and thereby cooled (via end cover fins 110) and distributed around the housing 12 for enhanced lubrication of the portions thereof and the parts mounted thereto.

Reference will now be made to FIG. 31, which is a front perspective view of an alternative housing body 312 according to another embodiment of the present invention. The housing body 312 is similar to housing body 12, but the primary difference is that each bearing abutment surface 350 defines cylindrical channels 354 extending through the front wall portion 332 or rear wall portion 334 respectively.

The operation of the housing 312 is identical to that of housing 12.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

In addition, the foregoing describes only some embodiments of the inventions, and alterations, modifications, additions and/or changes can be made thereto without departing from the scope of the disclosed embodiments, the embodiments being illustrative and not restrictive.

In the above description, where a specific number of features is described together with the words “in this embodiment”, or similar, then other embodiments may be used with a greater or fewer number of those features.

A skilled person, however, would understand that in alternative embodiments, the end cover abutment flange 86 may be any suitable configuration corresponding to the mounting surface perimeter 102 of end cover 100.

It should be appreciated that the fluid channels (of bearing cover) 156 and/or the fluid channels (of lower recess) 166 may be wider than illustrated in the drawings.

It will now be appreciated by those of skill in the art that the above exciter assembly 10 has many advantages. For example, the gears 26 may be mounted in the housing 12 via the opening 22, 24 in the opposing ends 18, 20 rather than through an upper opening that weakens and reduces the stiffness of a housing in the highest load direction. By using side openings to insert the gears 26, the overall housing 12 can be made lighter, thereby providing a better power to weight ratio.

The end covers 100 are simple in design and symmetric, allowing for easy machining and to be configured for various different sizes of housing 12 and for incorporating sensors.

The housing 12 provides easy access to the row of mounting apertures 84 in the feet 82 thereby facilitating the use of a Hytorc (trade mark) hydraulic torque wrench for use as a nut tightening tool (or hydraulic nuts) in mounting the housing 12 to a vibrating screen. The row of mounting apertures 84 is also optimised for bolting the housing 12 to nominal exciter beam sizes, web thicknesses, and beam widths.

The surface area of the housing 12 is increased compared with many prior art exciters, thereby providing improved thermal cooling performance.

The generally symmetrical housing design and eccentric weights 28 provide a symmetry of forces and therefore reduced bending.

### LIST OF REFERENCE NUMERALS

LIST OF REFERENCE NUMERALS

exciter assembly (exciter) 10
exciter body (housing) 12, 312
upper portion (top) of housing 14, 314
lower portion (bottom) of housing 16
opposing ends of housing 18, 20; 318, 320
openings (in opposing ends) 22, 24
gears 26
eccentric weights 28
exciter shafts 29
passageway (in housing) 30
front wall portion (of housing) 32, 332
back wall portion (of housing) 34, 334
central longitudinal plane (of housing) 36
central transverse plane (of housing) 38
through holes (of housing) 40, 42
bearing abutment surface (of housing) 50, 350
bearing 52
channels (of housing) 54, 354
chambers (of housing) 60, 62
arcuate upper surface (of chambers) 64
arcuate lower surface (of chambers) 66
lubricating fluid 70
lifting lugs (of housing) 80
feet (of housing) 82
mounting apertures (of feet) 84
end cover abutment flange (of housing) 86
threaded apertures (of housing) 88
end covers 100
mounting surface perimeter (of end cover) 102
arcuate base (of end cover) 104
front wall (of end cover) 106
back wall 108 (of end cover)
fins (of end cover) 110
central portion of base surface (of end cover) 112
apertures (of end cover) 114
cavity (of end cover) 116
apertures (of end cover) 118
oil apertures (of end cover) 120
oil plug 121
elongate member (rod) (of end cover) 122
bearing covers 140a,b
body (of bearing cover) 142
front (outer) side (of bearing cover) 144
rear (inner) side (of bearing cover) 146
central aperture (of bearing cover) 148
circular recess (of bearing cover) 150
upper recesses (of bearing cover) 152
lower recess (of bearing cover) 154
fluid channels (of bearing cover) 156
enlarged end portion (of upper recess) 158
narrow channel portion (of upper recess) 160
drain channel 161
lower edge (of lower recess) 162
protrusions (of lower recess) 164
fluid channels (of lower recess) 166
fins (of bearing cover) 170
apertures (of bearing cover) 180
weight body (of eccentric weight) 202
bore (of eccentric weight) 204
arms (of eccentric weight) 206
support cylinder (of eccentric weight) 208
removable weight (of eccentric weight) 210
peripheral sector member 212

1. An exciter housing for a vibrating screen, the housing comprising:
a unitary body having:
an upper portion;
a lower portion;
opposing walls comprising a front wall and a back wall;
opposing ends, at least one of the ends having an opening for receiving a gear; and,
a passageway extending between the ends and being defined by the upper and lower portions and the opposing walls;
wherein each of the opposing walls has a pair of spaced apart through holes and the passageway includes a pair of chambers, each chamber being in registration with corresponding spaced apart through holes, and each chamber extending transverse to the length of the passageway.

2. The exciter housing as claimed in claim 1, wherein each end has an opening for receiving a gear, and the passageway extends between the openings defined by the ends.

3. The exciter housing as claimed in claim 1, wherein a bearing cover abutment surface extends around each of the spaced apart through holes.

4. The exciter housing as claimed in claim 0, wherein the bearing cover abutment surface includes a plurality of channels, wherein the channels are circumferentially spaced around the through holes.

5. The exciter housing as claimed in claim 0, wherein each channel extends through the front and back walls such that a channel in one bearing cover abutment surface aligns with a respective channel in the opposing bearing cover abutment surface to provide fluid communication between one bearing cover abutment surface, the passageway, and the opposing bearing cover abutment surface.

6. The exciter housing as claimed in claim 1, wherein the chambers are configured to share an opening therebetween.

7. The exciter housing as claimed in claim 1, wherein the passageway includes a reservoir for holding a lubricating fluid.

8. The exciter housing as claimed in claim 1, wherein the upper portion includes a pair of spaced apart lugs configured to allow the body to be lifted at an angle.

9. The exciter housing as claimed in claim 0, wherein each lug is spaced inwardly from an end of the body.

10. The exciter housing as claimed in claim 1, wherein each end includes an end cover abutment surface for securing an end cover thereto.

11. The exciter housing as claimed in claim 1, wherein the body extends longitudinally and is generally symmetrical along at least one of a central longitudinal plane and a central transverse plane.

12. An exciter comprising:
an exciter housing body according to claim 1;
a pair of end covers, each end cover being mounted to an end of the exciter housing body and being configured to cover one of the opposing end openings; and
a pair of bearing covers, each bearing cover being mounted on a respective bearing cover abutment surface of the housing body;
wherein the housing body, end covers, and bearing covers form an internal cavity including the passageway and being configured to direct a contained fluid therearound.

13. An end cover for a unitary exciter housing body having a longitudinal passageway defined by a top, bottom, opposing sidewalls, and opposing ends, where each opposing end is smaller than the top, bottom or opposing sidewalls, and where at least one of the opposing ends defines an opening for receiving a gear, the end cover comprising:
a mounting surface perimeter for coupling to the exciter housing body;
an arcuate base upstanding from the mounting surface perimeter and having a front wall, a back wall spaced apart from the front wall, and a thermal cooling feature;
wherein the end cover is configured to cover the opening of the exciter housing body.

14. The end cover as claimed in claim 0, wherein the thermal cooling feature comprises a plurality of fins upstanding from the arcuate base.

15. The end cover as claimed in claim 0, wherein the arcuate base defines a cavity on an inner surface thereof.

16. The end cover as claimed in claim 0, wherein the mounting surface perimeter defines a lubrication aperture configured to receive a removable plug for draining or adding lubricating fluid to the cavity.
